(19) United States
(12) Patent Application Publication
(10) Pub. No.: US 2024/0157518 A1
(43) Pub. Date: May 16, 2024

(54) RATCHET WRENCH

(71) Applicant: JOHN METAL TOOLS INDUSTRIAL LTD., Taichung City (TW)

(72) Inventor: CHIEN-CHUAN KAO, Taichung City (TW)

(21) Appl. No.: 18/498,703

(22) Filed: Oct. 31, 2023

(30) Foreign Application Priority Data
Nov. 11, 2022 (TW) 111143116

(51) Int. Cl. B25B 13/46; B25B 23/00; B25G 1/08

(52) U.S. Cl. CPC B25B 13/462; B25B 23/0028; B25G 1/085

(57) ABSTRACT

A ratchet wrench is provided, including: a handle, a moving member and a positioning mechanism. The moving member is rotatably connected with the handle about a rotational axis and includes a driving head having a driving axis parallel to the rotational axis. The moving member is swingable between a folded position and an operating position. The positioning mechanism is disposed between the handle and the moving member and includes at least one restricting portion and a positioning member, and the positioning member is movable between a locking position and a release position. When the positioning member is in the locking position, the positioning member is interfered with one said restricting portion in a swinging direction of the moving member; when the positioning member is in the release position, the positioning member is free of interference with the at least one restricting portion in the swinging direction.

### BACKGROUND OF THE INVENTION

### Field of the Invention

The present invention relates to a ratchet wrench.

### Description of the Prior Art

A conventional ratchet wrench is long and inconvenient to carry and store, therefore, a foldable ratchet wrench has been developed. A conventional foldable ratchet wrench includes a handle and a ratchet head rotatably connected with the handle, and the ratchet head is swingable toward the handle so as to reduce the volume and facilitate portability.

However, a rotational axis of the ratchet head is generally vertical to a shaft connecting the handle with the ratchet head so that a torque transmitted between the handle and the ratchet head may be exerted on the shaft, which may cause damage to the shaft.

The present invention is, therefore, arisen to obviate or at least mitigate the above-mentioned disadvantages.

### SUMMARY OF THE INVENTION

The main object of the present invention is to provide a ratchet wrench, which is foldable and has good assembling stability.

To achieve the above and other objects, the present invention provides a ratchet wrench, including: a handle, a moving member and a positioning mechanism. The moving member is rotatably connected with the handle about a rotational axis and includes a driving head having a driving axis. The rotational axis is parallel to the driving axis, and the moving member is swingable relative to the handle between a folded position and an operating position. The positioning mechanism is disposed between the handle and the moving member and includes at least one restricting portion and a positioning member, and the positioning member is movable relative to the at least one restricting portion between a locking position and a release position.

When the positioning member is in the locking position, the moving member is in the folded position or the operating position, and the positioning member is interfered with one of the at least one restricting portion in a swinging direction of the moving member. When the positioning member is in the release position, the positioning member is free of interference with the at least one restricting portion in the swinging direction.

Two end portions of the handle extend toward the same side and define a receiving portion, and an inner surface of the handle facing the receiving portion at least partially corresponds to an outer contour of the moving member. When the moving member is in the folded position, the moving member is at least partially received within the receiving portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIG. 3 is a partial cross-sectional view showing a moving member in a folded position according to a preferable embodiment of the present invention;

FIG. 4 is a partial cross-sectional view showing operation of the moving member according to a preferable embodiment of the present invention;

FIG. 5 is a partial cross-sectional view showing the moving member in an operating position according to a preferable embodiment of the present invention;

FIG. 6 is a cross-sectional view showing a positioning member in a release position according to a preferable embodiment of the present invention; and

FIG. 7 is a cross-sectional view showing the positioning member in a locking position according to a preferable embodiment of the present invention.

### DETAILED DESCRIPTION OF THE PREFERRED EMBODIMENTS

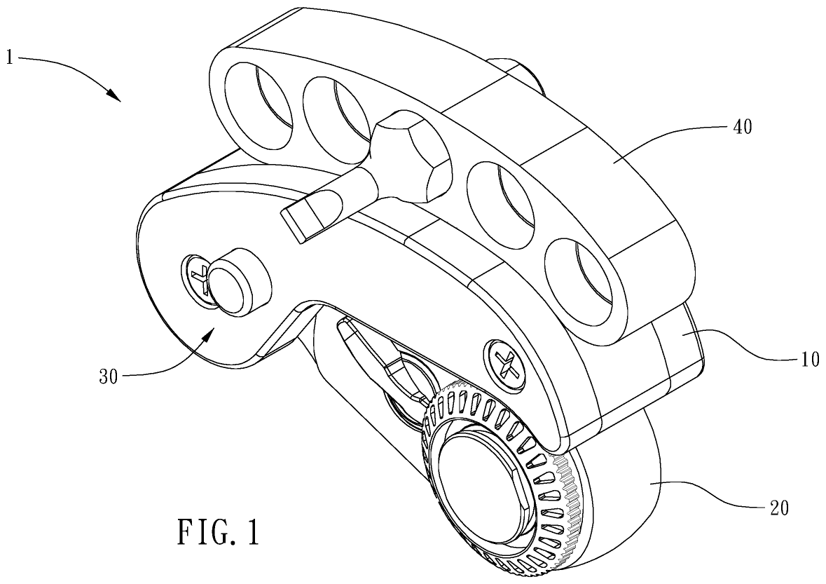

Please refer to FIGS. 1 to 7 for a preferable embodiment of the present invention. A ratchet wrench 1 of the present invention includes a handle 10, a moving member 20 and a positioning mechanism 30.

The moving member 20 is rotatably connected with the handle 10 about a rotational axis R, and the moving member 20 includes a driving head 21 having a driving axis D. The rotational axis R is parallel to the driving axis D, and the moving member 20 is swingable relative to the handle 10 between a folded position and an operating position. The positioning mechanism 30 is disposed between the handle 10 and the moving member 20 and includes at least one restricting portion 31 and a positioning member 32. The positioning member 32 is movable relative to the at least one restricting portion 31 between a locking position and a release position. When the positioning member 32 is in the locking position, the moving member 20 is in the folded position or the operating position, and the positioning member 32 is interfered with one of the at least one restricting portion 31 in a swinging direction of the moving member 20. When the positioning member 32 is in the release position, the positioning member 32 is free of interference with the at least one restricting portion 31 in the swinging direction. Therefore, the ratchet wrench 1 is foldable for easy portability and storage, and a torque transmitted between the moving member 20 and the handle 10 is dispersed so as to provide good assembling stability and be durable to use.

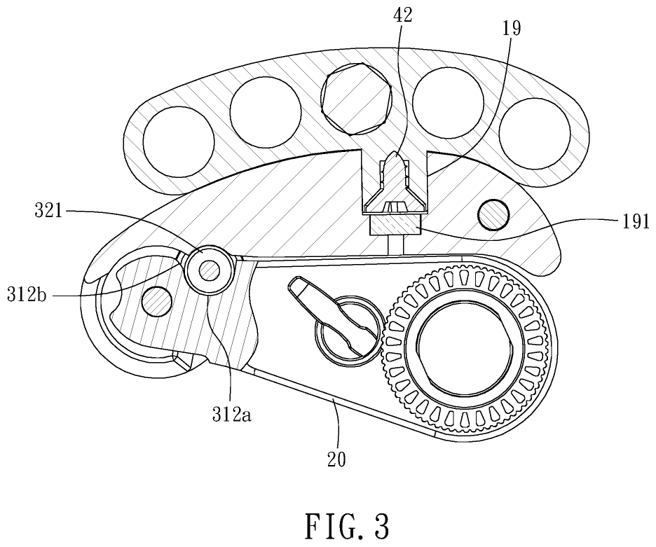

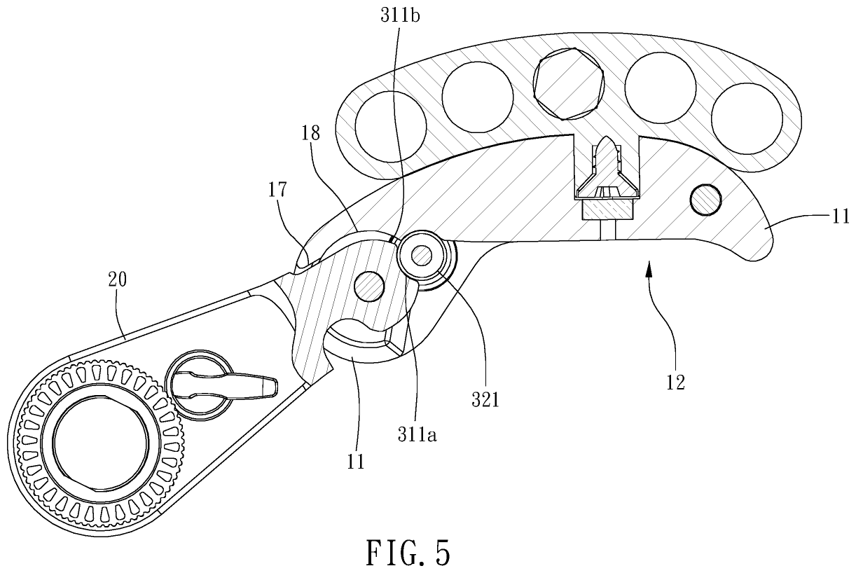

The at least one restricting portion 31 includes a first restricting portion 311, and the first restricting portion 311 includes a first positioning groove 311a and a first abutting protrusion 311b adjacent to the first positioning groove 311a. When the moving member 20 is in the operating position and the positioning member 32 is in the locking position, the positioning member 32 is received within the first positioning groove 311a and is abuttable against the first abutting protrusion 311b in the swinging direction so that the moving member 20 is positioned in the operating position and the ratchet wrench 1 is easy to operate, as shown in FIG. 5. The at least one restricting portion 31 further includes a second restricting portion 312, and the second restricting portion 312 includes a second positioning groove 312a and a second abutting protrusion 312b adjacent to the second positioning groove 312a. When the moving member 20 is in the folded position and the positioning member 32 is in the locking position, the positioning member 32 is received within the second positioning groove 312a and is abuttable against the second abutting protrusion 312b in the swinging direction so that the moving member 20 is positioned in the folded position to prevent the ratchet wrench 1 from being unfolded during being carried, as shown in FIGS. 1 and 3. The first positioning groove 311a and the second positioning groove 312a are disposed on the moving member 20 and are open in different directions, and a depth of the first positioning groove 311a is different from a depth of the second positioning groove 312a. In this embodiment, the depth of the first positioning groove 311a is smaller than the depth of the second positioning groove 312a, which allows the positioning member 32 to be stably restricted and the ratchet wrench 1 to be minimized after being folded. In other embodiments, opening directions and depths of the first positioning groove and the second positioning groove may be changed to meet different requirements.

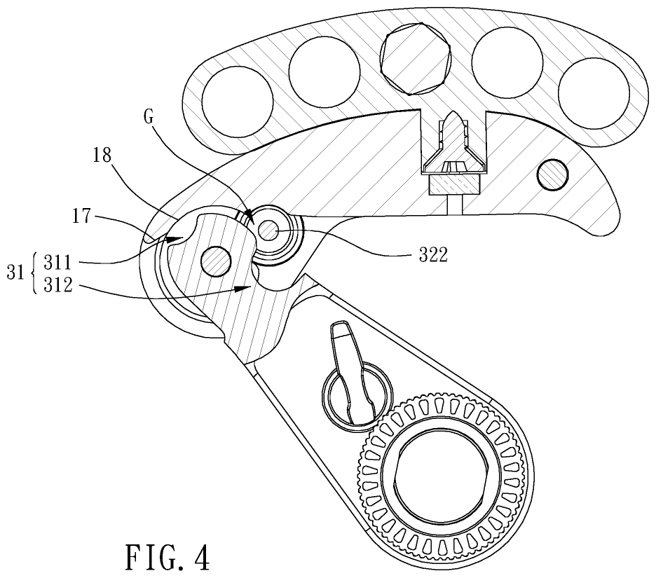

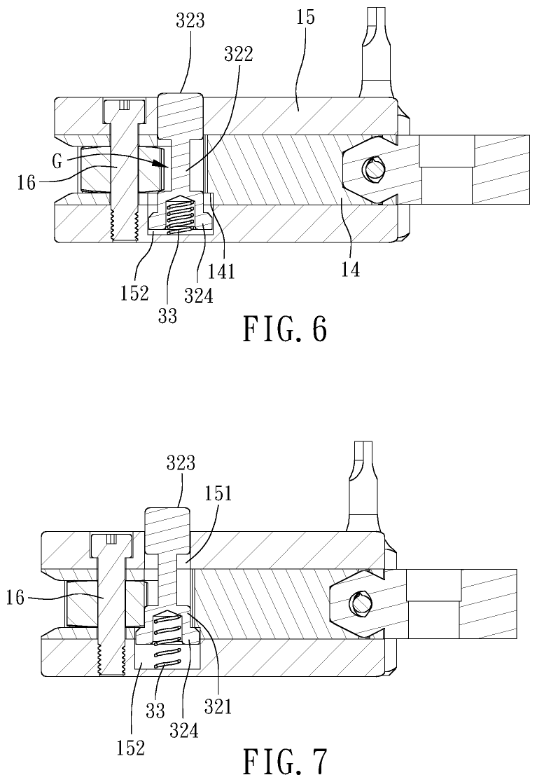

Specifically, the positioning member 32 extends in a direction parallel to the rotational axis R and includes a large diameter segment 321 and a small diameter segment 322. When the positioning member 32 is in the locking position, the large diameter segment 321 corresponds to and is abuttable against one of the at least one restricting portion 31 in the swinging direction, as shown in FIG. 7. When the positioning member 32 is in the release position, the small diameter segment 322 and one of the at least one restricting portion 31 correspond to each other and define a dodge gap G, as shown in FIGS. 4 and 6, which allows the moving member 20 to be swung smoothly relative to the handle 10. In this embodiment, the positioning mechanism 30 further includes an elastic member 33 disposed between the handle 10 and the positioning member 32, and the elastic member 33 is elastically abutted against the positioning member 32 in a direction parallel to the rotational axis R so that the positioning member 32 has a tendency to move toward the locking position, thereby automatically returning to its original position. The positioning member 32 further includes an operation end 323, and the operation end 323 protrudes beyond an outer surface of the handle 10 when the positioning member 32 is in the locking position. The positioning member 32 is moved to the release position by pressing the operation end 323, which is convenient to use. In other embodiments, the positioning mechanism may restrict the positioning member by an engaging structure without the elastic member; the positioning mechanism may further include an operating member, and the positioning member may be driven to move by pulling, switching or turning the operating member.

Preferably, two end portions 11 of the handle 10 extend toward the same side and define a receiving portion 12, and an inner surface of the handle 10 facing the receiving portion 12 at least partially corresponds to an outer contour of the moving member 20. When the moving member 20 is in the folded position, the moving member 20 is at least partially received within the receiving portion 12 to facilitate miniaturization. The handle 10 has an assembling hole 13 open toward the receiving portion 12, and the positioning member 32 is disposed within the assembling hole 13. When the moving member 20 is swung toward the folded position, the moving member 20 is moved toward the handle 10 until the positioning member 32 is received within the second positioning groove 312a. The two end portions 11 of the handle 10 extend with different curvatures so that an outer contour of the ratchet wrench 1 is smooth after being folded.

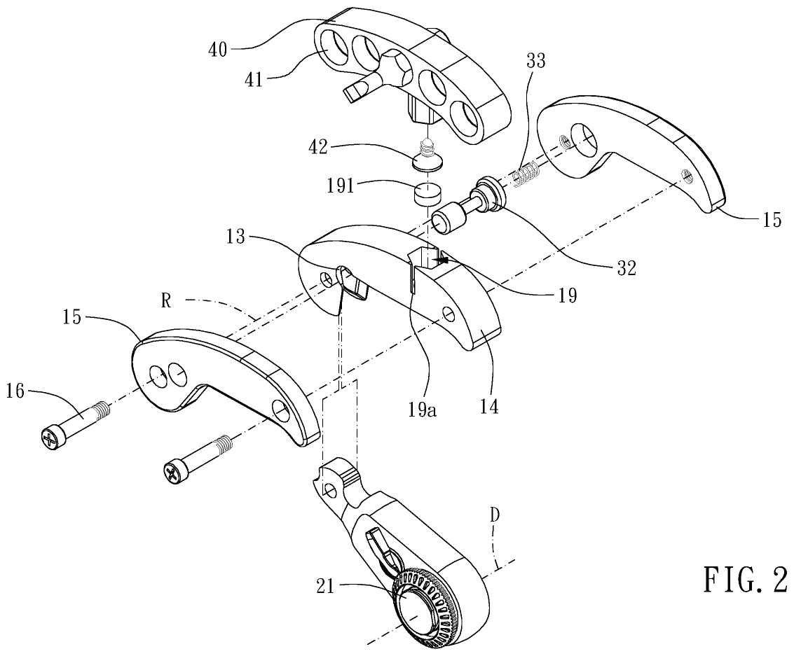

Please refer to FIGS. 2, 6 and 7, the handle 10 includes a main body 14 and two side boards 15 disposed on two opposite sides of the main body 14, and a plurality of fasteners 16 detachably connect the main body 14 with the two side boards 15. One of the plurality of fasteners 16 is disposed through the moving member 20 and the handle 10 in the rotational axis R and serves as a rotating shaft, which is easy to assemble and has good structural strength. Moreover, the main body 14 has a stepped portion 141 surrounding the assembling hole 13, one of the two side boards 15 has a through hole 151 corresponding to the assembling hole 13, and the other of the two side boards 15 has a notch 152 corresponding to the stepped portion 141. The positioning member 32 further includes an assembling section 324 adjacently connected with the large diameter segment 321, the operation end 323 is disposed through the through hole 151, and the assembling section 324 is received within the notch 152 and axially abuttable against the stepped portion 141 so as to have a simple structure and good assembling stability and be easy to assemble.

Preferably, the handle 10 includes a restricting surface 17 facing the moving member 20 and an arcuate concave surface 18 extending around the rotational axis R, and the arcuate concave surface 18 is adjacently connected with the restricting surface 17 and corresponds to a portion of an outer surface of the moving member 20 so that the moving member 20 can be swung smoothly. When the moving member 20 is in the operating position, the moving member 20 is abuttable against the restricting surface 17 so as to disperse force exerted between the moving member 20 and the handle 10 and avoid damage to the rotating shaft.

The handle 10 further includes at least one insertion groove 19, and the at least one insertion groove 19 is configured to receive at least one tool head for easy storage and good portability. Preferably, the ratchet wrench 1 further includes an insertion seat 40 disposed within the at least one insertion groove 19, and the insertion seat 40 includes a plurality of receiving grooves 41 configured to receive the at least one tool head. The insertion seat 40 is replaceable to meet different storage requirements. The insertion seat 40 at least partially extends along a surface of the handle 10 facing the insertion seat 40. In this embodiment, at least a portion of the insertion seat 40 is made of an elastic material, such as rubber, and each of the plurality of receiving grooves 41 is a circular through hole. The insertion seat 40 is elastically deformable so as to restrict each said tool head. The handle 10 further includes at least one slot 19a communicated with the at least one insertion groove 19, and the insertion seat 40 is elastically deformed to be embedded within one of the at least one insertion groove 19 and the at least one slot 19a so as to have good assembling stability. The handle 10 may further include a first magnetic member 191 disposed on a bottom of one of the at least one insertion groove 19, and the insertion seat 40 has a second magnetic member 42 being attractable with the first magnetic member 191. Therefore, the insertion seat 40 is stably inserted within one of the at least one insertion groove 19 by magnetic attraction. In other embodiments, the insertion seat may be made of metal, plastic, silicone, or other materials; each of the plurality of receiving grooves may be a through hole or a blind hole in a square, hexagonal, or other shape.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A ratchet wrench, including:
a handle;
a moving member, rotatably connected with the handle about a rotational axis, including a driving head having a driving axis, the rotational axis being parallel to the driving axis, the moving member being swingable relative to the handle between a folded position and an operating position; and
a positioning mechanism, disposed between the handle and the moving member, including at least one restricting portion and a positioning member, the positioning member being movable relative to the at least one restricting portion between a locking position and a release position;
wherein when the positioning member is in the locking position, the moving member is in the folded position or the operating position, the positioning member is interfered with one of the at least one restricting portion in a swinging direction of the moving member; when the positioning member is in the release position, the positioning member is free of interference with the at least one restricting portion in the swinging direction;
wherein two end portions of the handle extend toward the same side and define a receiving portion, an inner surface of the handle facing the receiving portion at least partially corresponds to an outer contour of the moving member; when the moving member is in the folded position, the moving member is at least partially received within the receiving portion.

2. The ratchet wrench of claim 1, wherein the positioning member extends in a direction parallel to the rotational axis and includes a large diameter segment and a small diameter segment; when the positioning member is in the locking position, the large diameter segment corresponds to and is abuttable against one of the at least one restricting portion in the swinging direction; and when the positioning member is in the release position, the small diameter segment and one of the at least one restricting portion corresponds to each other and define a dodge gap therebetween.

3. The ratchet wrench of claim 1, wherein the at least one restricting portion includes a first restricting portion, the first restricting portion includes a first positioning groove and a first abutting protrusion adjacent to the first positioning groove; and when the moving member is in the operating position and the positioning member is in the locking position, the positioning member is received within the first positioning groove and is abuttable against the first abutting protrusion in the swinging direction.

4. The ratchet wrench of claim 3, wherein the at least one restricting portion further includes a second restricting portion, the second restricting portion includes a second positioning groove and a second abutting protrusion adjacent to the second positioning groove; when the moving member is in the folded position and the positioning member is in the locking position, the positioning member is received within the second positioning groove and is abuttable against the second abutting protrusion in the swinging direction.

5. The ratchet wrench of claim 1, wherein the handle includes a restricting surface facing the moving member and an arcuate concave surface extending around the rotational axis, the arcuate concave surface is adjacently connected with the restricting surface and corresponds to a portion of an outer surface of the moving member; and when the moving member is in the operating position, the moving member is abuttable against the restricting surface.

6. The ratchet wrench of claim 1, wherein the handle includes at least one insertion groove, and the at least one insertion groove is configured to receive at least one tool head.

7. The ratchet wrench of claim 6, further including an insertion seat disposed within the at least one insertion groove, wherein the insertion seat includes a plurality of receiving grooves configured to receive the at least one tool head, and the insertion seat at least partially extends along a surface of the handle facing the insertion seat.

8. The ratchet wrench of claim 1, wherein the handle has an assembling hole open toward the receiving portion, and the positioning member is disposed within the assembling hole.

9. The ratchet wrench of claim 4, wherein the first positioning groove and the second positioning groove are disposed on the moving member and are open in different directions; the positioning member extends in a direction parallel to the rotational axis and includes a large diameter segment and a small diameter segment; when the positioning member is in the locking position, the large diameter segment corresponds to and is abuttable against one of the at least one restricting portion in the swinging direction; and when the positioning member is in the release position, the small diameter segment and one of the at least one restricting portion correspond to each other and define a dodge gap therebetween; the positioning mechanism further includes an elastic member disposed between the handle and the positioning member, the elastic member is elastically abutted against the positioning member in a direction parallel to the rotational axis so that the positioning member has a tendency to move toward the locking position; the positioning member further includes an operation end, and the operation end protrudes beyond an outer surface of the handle when the positioning member is in the locking position; the handle includes a restricting surface facing the moving member and an arcuate concave surface extending around the rotational axis, the arcuate concave surface is adjacently connected with the restricting surface and corresponds to a portion of an outer surface of the moving member; and when the moving member is in the operating position, the moving member is abuttable against the restricting surface; the handle includes at least one insertion groove, and the at least one insertion groove is configured to receive at least one tool head; the ratchet wrench further includes an insertion seat disposed within the at least one insertion groove, the insertion seat includes a plurality of receiving grooves configured to receive the at least one tool head, and the insertion seat at least partially extends along a surface of the handle facing the insertion seat; at least a portion of the insertion seat is made of an elastic material, and each of the plurality of receiving grooves is a circular through hole; the handle has an assembling hole open toward the receiving portion, and the positioning member is disposed within the assembling hole; the two end portions of the handle extend with different curvatures; a depth of the first positioning groove is different from a depth of the second positioning groove; the handle includes a main body and two side boards disposed on two opposite sides of the main body, a plurality of fasteners detachably connect the main body with the two side boards, one of the plurality of fasteners is disposed through the moving member and the handle in the rotational axis and serves as a rotating shaft; and the main body has a stepped portion surrounding the assembling hole, the positioning member further includes an assembling section adjacently connected with the large diameter segment, and the assembling section is axially abuttable against the stepped portion.
